(19) United States
(12) Patent Application Publication
(10) Pub. No.: US 2021/0297596 A1
(43) Pub. Date: Sep. 23, 2021

(54) LENS DRIVING DEVICE, CAMERA MODULE, AND CAMERA-MOUNTED APPARATUS

(71) Applicant: MITSUMI ELECTRIC CO., LTD, Tokyo (JP)

(72) Inventor: Yohei ENTA, Tokyo (JP)

(73) Assignee: MITSUMI ELECTRIC CO., LTD., Tokyo (JP)

(21) Appl. No.: 16/321,477

(22) PCT Filed: Jul. 27, 2017
(86) PCT No.: PCT/JP2017/027290

§ 371 Date: Jan. 29, 2019

(30) Foreign Application Priority Data
Jul. 29, 2016 (JP) 2016-150291

(51) Int. Cl. H04N 5/232; G02B 7/09; G02B 7/10; G03B 5/02; H04N 5/225

(52) U.S. Cl. CPC H04N 5/23287; G02B 7/09; G02B 7/10; G03B 2205/0007; H04N 5/2253; G03B 2205/0069; G03B 5/02

(57) ABSTRACT

The lens driving device is provided with: a shake correction driving unit that has a shake correction magnet and a shake correction coil, and that performs shake correction by causing a shake correction movable unit including the shake correction magnet to oscillate within a plane orthogonal to the optical axis direction with respect to a shake correction fixation unit which includes the shake correction coil, by use of the driving force of a voice coil motor configured with the shake correction coil and the shake correction magnet; and an elastic support member that supports the shake correction movable unit so as to oscillate with respect to the shake correction fixation unit, wherein the shake correction movable unit has, in the lens arranging region, a plurality of lens mounting parts to which a plurality of lenses are mounted.

### TECHNICAL FIELD

The present invention relates to a lens driving device for autofocusing, a camera module having an autofocus function, and a camera-mounted device.

### BACKGROUND ART

In general, a small camera module is mounted on a portable terminal such as a smart phone. Such a camera module may be provided with a lens driving device with an autofocus function (hereinafter referred to as “AF function”, AF: Auto Focus) configured to automatically perform focusing when photographing an object, and a shake correction function (hereinafter, referred to as “OIS function”, OIS: Optical Image Stabilization) configured to optically correct shaking (vibration) that may occur at the time of photographing and alleviate image blur (For example, PTLs 1 and 2).

An autofocusing and shake correcting lens driving device includes an autofocusing driving part configured to move a lens part in an optical axis direction (hereinafter, referred to as “AF driving part”) and a shake correcting driving part configured to swing the lens part in a plane orthogonal to the optical axis direction (hereinafter, referred to as “OIS driving part”).

The AF driving part includes, for example, an autofocusing coil part (hereinafter, referred to as “AF coil part”) disposed around the lens part, and an autofocusing magnet part (hereinafter referred to as “AF magnet part”) disposed radially apart from the AF coil part. Using a driving force of a voice coil motor composed of the AF coil part and the AF magnet part, an autofocus movable part (hereinafter referred to as “AF movable part”) including the lens part and the AF coil part is moved with respect to an autofocusing fixing part (hereinafter referred to as “AF fixing part”) including the AF magnet part in the optical axis direction to achieve automatic focusing. A combination of the AF movable part and the AF fixing part is referred to as “autofocus unit (AF unit)”.

The OIS driving part includes, for example, a shake correcting magnet part (hereinafter, referred to as “OIS magnet part”) disposed on the AF unit and a shake correcting coil part (hereinafter, referred to as “OIS coil part”) disposed apart from the OIS magnet part in the optical axis direction. A shake correcting movable part (hereinafter, referred to as “OIS movable part”) including the AF unit and the OIS magnet part is supported by a resilient supporting member in a state of being apart from a shake correcting fixing part (hereinafter, referred to as “OIS fixing part”) including the OIS coil part in the optical axis direction. The shake correction is performed by swinging the OIS movable part in a plane orthogonal to the optical axis direction using a driving force of the voice coil motor composed of the OIS magnet part and the OIS coil part.

In addition, according to the disclosure in PTLs 1 and 2, the same magnet part is commonly used for the OIS magnet part and the AF magnet part in terms of achievement of a lens driving device with small size and low height. The magnet part that is commonly used as the OIS magnet part and the AF magnet part is referred to as “driving magnet part”.

Proposed in PTL 2 is a system including a Hall element placed on the AF fixing part and a position detecting magnet placed on the AF movable part, in which the Hall element detects the position of the AF movable part, and an action of the voice coil motor for the AF driving part is controlled based on a result of detection (so-called closed-loop control system). According to the closed-loop control system, it is possible to detect that the position of the AF movable part is stabilized without considering hysteresis characteristics of the voice coil motor. In addition, the closed-loop control system may support an automatic focusing of an image surface detection system. Therefore, high response performance is achieved and thus the speed of an automatic focusing operation may be increased.

### CITATION LIST

### Patent Literature

### PTL 1

### Japanese Patent Application Laid-Open No. 2013-210550

### PTL 2

### Japanese Patent Application Laid-Open No. 2012-177753

### SUMMARY OF INVENTION

### Technical Problem

In recent years, a camera module including a plurality of (typically two) lens driving devices, a so-called dual camera is now in the course of practical application. The dual camera has various possibilities depending on usage scenes such as being capable of taking two images at different focal distances simultaneously or being capable of taking a still image and a moving picture simultaneously.

When the lens driving devices described in PTLs 1 and 2 are applied to the dual camera, two lens driving devices are arranged adjacent to each other. Arranging the two lens driving devices side by side may lead to a risk of causing a problem in operation due to a magnetic interference between the adjacent driving magnet parts. In addition, for example, when the driving magnet part of one of the lens driving devices has the shake correction function, and a shake correcting movable part having a magnet for shake correction is attracted by a yoke of the other lens driving device, so that the position of the lens is deviated in a plane orthogonal to the optical axis. Therefore, when two of the lens driving devices are arranged side by side, the both devices need to be apart from each other to some extent. In contrast, a dual camera that allows for achievement of a size reduction is desired as a dual camera product.

An object of the present invention is to provide a lens driving device, a camera module, and a camera-mounted device capable of easily achieving a size reduction of a dual camera.

### Solution to Problem

A lens driving device according to one aspect of the present invention includes:

a shake correcting driving part that includes:
a shake correcting magnet part disposed so as to surround a lens part placing region where a lens part is placed, and
a shake correcting coil part disposed apart from the shake correcting magnet part in an optical axis direction,

in which the shake correcting driving part sways a shake correcting movable part including the shake correcting magnet part with respect to a shake correcting fixing part including the shake correcting coil part in a plane orthogonal to the optical axis direction by using a driving force of a voice coil motor including the shake correcting coil part and the shake correcting magnet part; and

a resilient supporting member that supports the shake correcting movable part so that the shake correcting movable part is capable of swaying with respect to the shake correcting fixing part, in which

the shake correcting movable part includes a plurality of lens mounting parts that accommodate a plurality of the lens parts respectively in the lens part placing region.

A camera module according to one aspect of the present invention includes: a lens driving device of the above configuration; a plurality of lens parts that are mounted respectively on the lens mounting parts; and an image capturing part configured to capture a subject image imaged by the lens part. A camera-mounted device according to one aspect of the present invention is a camera-mounted module device that is an information device or a transporting device, the camera-mounted device including the camera module.

### Advantageous Effects of Invention

According to the present invention, a size reduction of a dual camera is easily achieved.

### BRIEF DESCRIPTION OF DRAWINGS

FIGS. 1A and 1B are drawings illustrating a smart phone including a camera module provided with a lens driving device according to an embodiment of the present invention;

FIG. 2 is a perspective view illustrating an appearance of the camera module;

FIG. 3 is a drawing illustrating a state of a lens driving device with a shield cover removed;

FIG. 4 is an exploded perspective view of the lens driving device;

FIG. 5 is an exploded perspective view of an OIS movable part;

FIG. 6 is a bottom view of the OIS movable part;

FIG. 7 is a cross-sectional view taken along a line A-A in FIG. 2;

FIG. 8 is a cross-sectional view taken along a line B-B in FIG. 2;

FIG. 9 is an exploded perspective view of an OIS fixing part; and

FIGS. 10A and 10B are drawings of an automotive vehicle as a camera-mounted device provided with a vehicle-mounted camera module.

### DESCRIPTION OF EMBODIMENTS

Embodiments of the present invention will be described in details below with reference to the accompanying drawings.

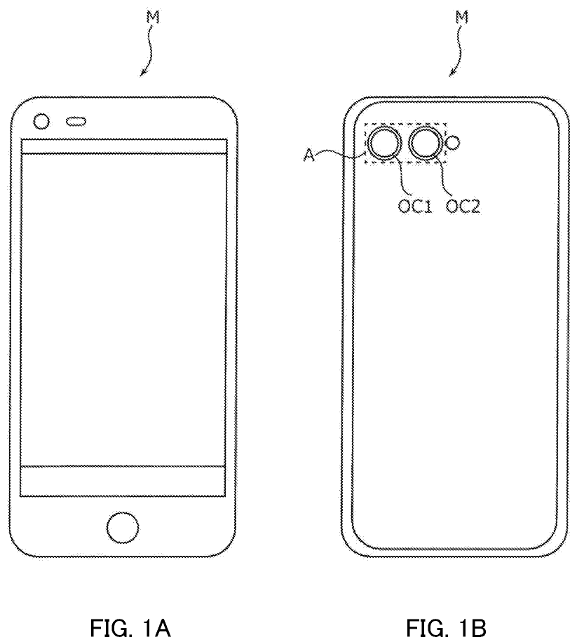

FIGS. 1A and 1B illustrate smartphone M (camera-mounted device) including camera module A provided with a lens driving device according to an embodiment of the present invention. Smartphone M includes a dual camera including two rear-facing cameras OC1 and OC2. Camera module A is applied as both rear-facing cameras OC1 and OC2 of the dual camera.

Camera module A has an autofocus function for each of cameras OC1 and OC2, so that an image without blur is taken by focusing automatically when photographing an object and optically correcting shaking (vibration) that may occur at the time of photographing.

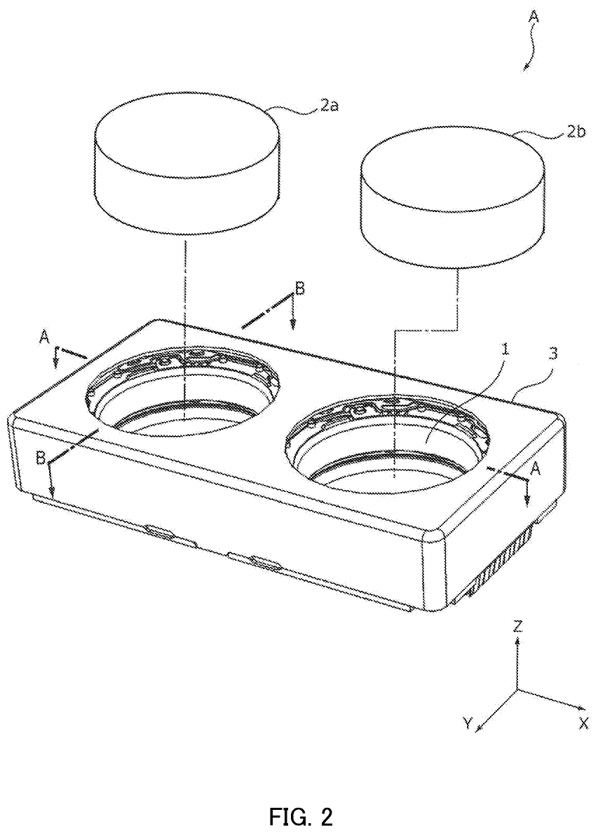

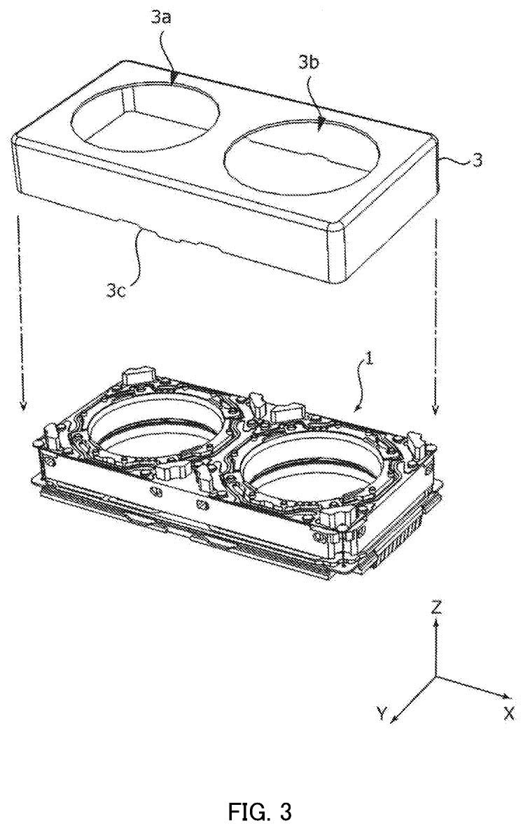

FIG. 2 is a perspective view illustrating an appearance of camera module A. FIG. 3 is a drawing illustrating a state of lens driving device 1 with shield cover 3 removed.

As illustrated in FIGS. 2 and 3, an orthogonal coordinate system (X, Y, Z) will be used in this embodiment. The accompanying drawings described later are also illustrated in the same orthogonal coordinate system (X, Y, Z). Camera module A is mounted in such an orientation that an X direction corresponds to a vertical direction (or lateral direction), a Y direction corresponds to a lateral direction (or vertical direction), and a Z direction corresponds to a fore-and-aft direction when a picture is taken actually by Smartphone M. In other words, the Z direction corresponds to an optical axis direction, and an upper side in the figure corresponds to a light receiving side (also referred to as “macro position”) in the optical axis direction, and a lower side corresponds to an image forming side (also referred to as “infinity position”) in the optical axis direction.

Camera module A includes a plurality of lens parts 2a and 2b made up of a lens contained in a lens barrel having a cylindrical shape, lens driving device 1, an image capturing part (not illustrated) configured to capture an image of an object image formed by each of lens parts 2a and 2b, and shield cover 3 covering the entire part.

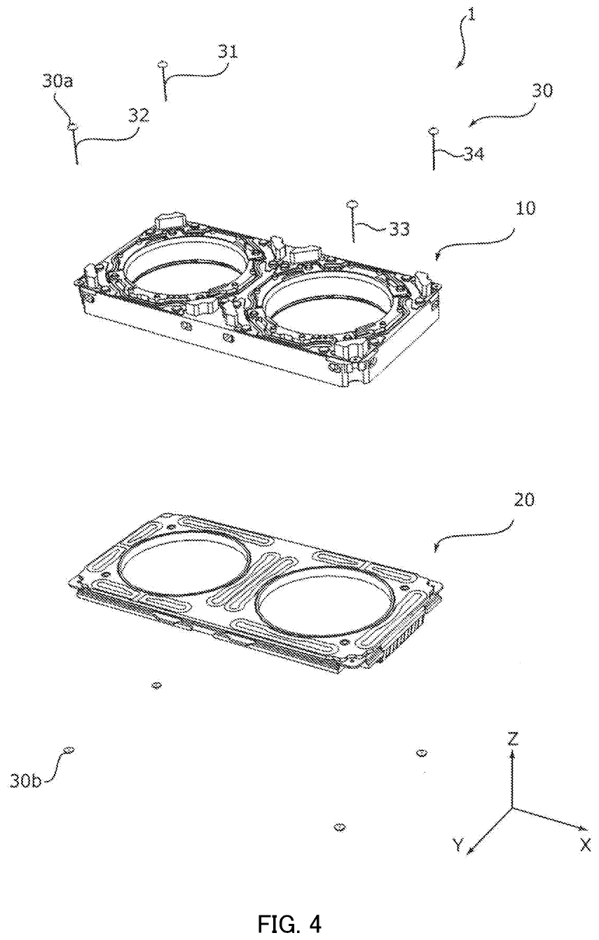

Lens driving device 1 includes lens part placing regions where lens parts 2a and 2b are placed, and lens movable parts 11a and 11b (see FIG. 4) configured to serve as lens mounting parts where lens parts 2a and 2b are mounted are disposed in the lens part placing regions. Lens driving device 1 is a driving device for autofocus and shake correction, and is only required to have at least the shake correction function for both of plurality of lens parts 2a and 2b. The autofocus function is not specifically required for lens parts 2a and 2b, but may be provided for at least one or more lens parts, and if it is a dual camera, is preferably provided for both of lens parts 2a and 2b.

Shield cover 3 is a rectangular tubular member with a lid having a square shape in plan view in the optical axis direction, and includes a plurality of openings 3a and 3b on an upper surface thereof. Openings 3a and 3b have a circular shape, and in this embodiment, openings 3a and 3b have a circular shape. Lens parts 2a and 2b (see FIG. 2) are exposed to the outside through openings 3a and 3b. Shield cover 3 has engaging depression 3c on a bottom portion thereof for mounting to lens driving device 1 (base member 23). Engaging depression 3c is formed on a bottom of shield cover 3, that is, on an end edge of the bottom side of the cylindrical body.

The image capturing part (not illustrated) includes an imaging element (not illustrated), and is arranged on the image forming side of lens driving device 1 in the optical axis direction. The imaging element (not illustrated) includes, for example, a charge coupled device (CCD) type image sensor, and a complementary metal oxide semiconductor (CMOS) type image sensor and the like. The imaging element (not illustrated) takes an object image formed by the lens part (not illustrated).

FIG. 4 is an exploded perspective view of lens driving device 1.

As illustrated in FIG. 4, lens driving device 1 includes OIS movable part 10, OIS fixing part 20, resilient supporting member 30, and the like. OIS movable part 10 is a part including an OIS magnet part which constitutes an OIS voice coil motor and swinging in an X-Y plane at the time of shake correction. OIS fixing part 20 is a portion including the OIS coil part. In other words, a lens driving part for OIS of lens driving device 1 employs a moving magnet system. OIS movable part 10 is no other than “AF unit” including the AF driving part.

OIS movable part 10 is placed apart from OIS fixing part 20 on the light receiving side in the optical axis direction, and is coupled to OIS fixing part 20 by resilient supporting member 30. Resilient supporting member 30 is composed of a plurality of suspension wires extending along the Z direction (hereinafter, referred to as “suspension wires 30”). In this embodiment, resilient supporting member 30 is composed of four suspension wires 30 (31 to 34). One end (upper end) of each of suspension wires 30 is fixed to OIS movable part 10 (upper resilient supporting part 13) via mounting strip 30a, and the other end (lower end) is fixed to OIS fixing part 20 (coil substrate 21) via mounting strip 30b. OIS movable part 10 is swingably supported in the XY plane by suspension wires 30.

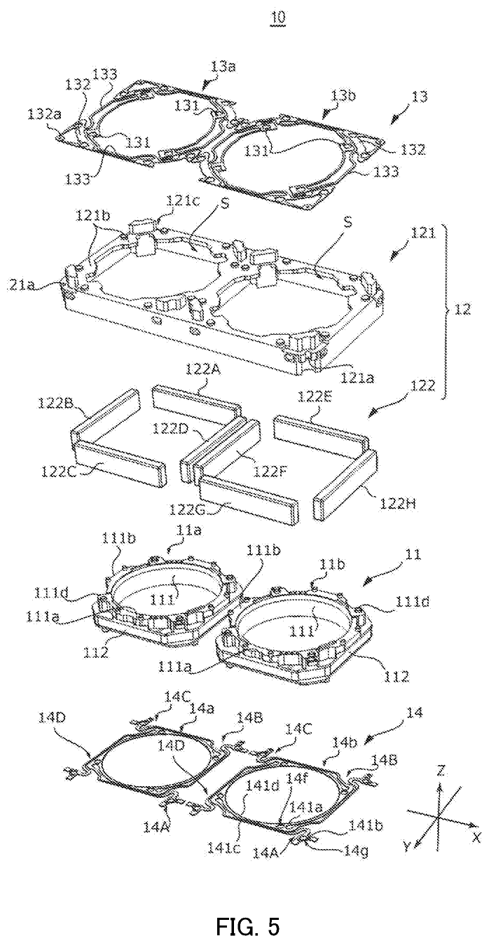

When an electronic component requiring power supply such as a Hall element used for position detection is provided on OIS movable part 10 side, any one of the plurality of (four in this embodiment) suspension wires 30 may be used as a power feeding path or a signal path for the electronic component. In such a case, the corresponding suspension wire is connected to a circuit board on OIS fixing part 20 side. For example, suspension wires 30 are used as power feeding paths to AF coil parts 112 (see FIG. 5) (used as suspension wires for feeding power to coils). The number of suspension wires 30 that constitute the resilient supporting member is not limited to four, and may be more than four. Alternatively, if at least two suspension wires 30 are arranged along the X axis direction and the Y axis direction respectively around lens parts 2a and 2b, six or even eight suspension wires may be provided.

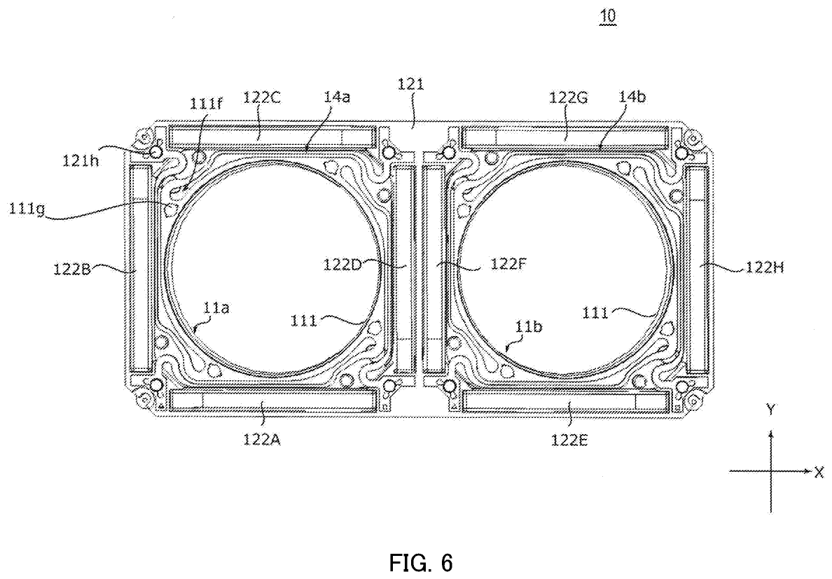

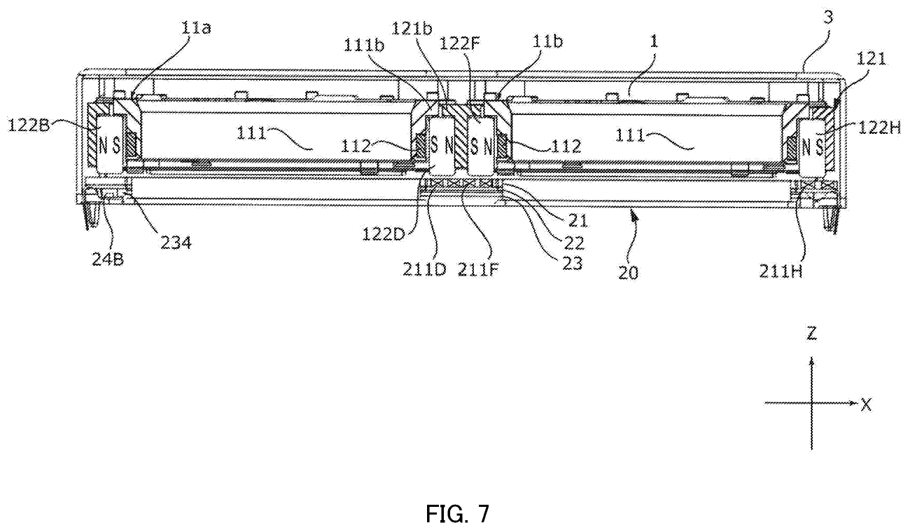

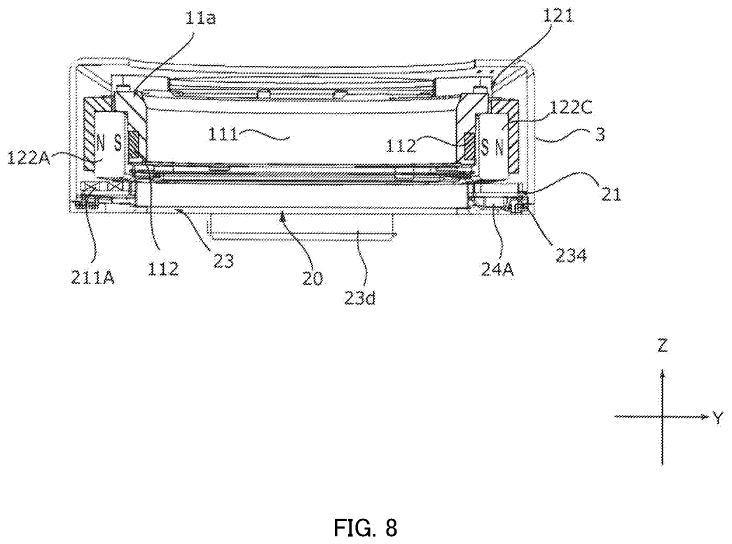

FIG. 5 is an exploded perspective view of OIS movable part 10, and FIG. 6 is a bottom view of OIS movable part. FIG. 7 is a cross-sectional view taken along the line A-A in FIG. 2, and FIG. 8 is a cross-sectional view taken along the line B-B in FIG. 2. FIG. 7 is a cross-sectional view taken along the line A-A viewed in the X direction, and FIG. 8 is a cross-sectional view taken along the line B-B viewed in −Y direction.

As illustrated in FIG. 5, OIS movable part 10 (AF unit) includes AF movable parts 11a and 11b, AF fixing part 12, upper resilient supporting part 13, lower resilient supporting part 14, and the like. AF movable parts 11a and 11b function as a lens mounting parts, and lens barrels of the plurality of lens parts are mounted respectively. AF movable parts 11a and 11b are formed respectively in a same manner. In lens driving device 1, AF movable parts 11a and 11b are placed side by side and apart from each other in an lens mounting region radially inside AF fixing part 12, and are coupled to AF fixing part 12 respectively by upper resilient supporting part 13 and lower resilient supporting part 14.

Each of AF movable parts 11a and 11b is a part including a coil part which constitutes AF voice coil motor, and moving in the optical axis direction at the time of focusing. AF fixing part 12 is a part having a magnet parts which constitute AF voice coil motors for respective AF movable parts 11a and 11b. In other words, AF lens driving parts of lens driving device 1 employ a moving coil system.

AF movable parts 11a and 11b each include lens holder 111 and AF coil part 112.

Lens holders 111 are cylindrical members that fix lens parts 2a and 2b (see FIG. 2) on inner peripheral surfaces thereof by adhesion or screwing.

Lens holders 111 of respective movable parts 11a and 11b each include a chamfered square coil winding wire part 111a on a lower half of a peripheral surface thereof. Lens holders 111 each include upward protruding parts 111b that protrude radially outward at four positions intersecting with the X direction and Y direction (hereinafter, referred to as a cross direction) on an upper half part of the peripheral surface. Upward protruding parts 111b are formed to protrude radially outward with respect to coil winding wire parts 111a. Upper surfaces of upward protruding parts 111b serve as locked portions configured to restrict AF movable part 11 from moving to the light receiving side in the optical axis direction, and lower surfaces of upward protruding parts 111b serve as locked portions configured to restrict AF movable part 11 from moving to the image forming side in the optical axis direction.

Lens holders 111 each include protruding parts 111d that protrude radially outward at four corners intersecting with a direction in which the cross direction is rotated by 45 degrees (hereinafter, referred to as “diagonal direction”) on an upper half portion of the peripheral surface. Protruding parts 111d serve as upper spring fixing portions configured to fix upper resilient supporting part 13 (hereinafter, referred to as “upper spring fixing parts 111d”).

Upper spring fixing parts 111d each include upper bosses configured to position and fix upper resilient supporting part 13. Note that two upper spring fixing parts 111d located at a pair of diagonal portions out of upper spring fixing parts 111d include tie-up parts protruding radially outward and configured to tie up coils of AF coil parts 112. In addition, position detecting magnets, not illustrated, configured to detect positions of AF coil parts 112 may be placed in two upper spring fixing parts 111d out of upper spring fixing parts 111d located at another pair of diagonal portions.

Lens holders 111 each include lower spring fixing parts 111f configured to fix lower resilient supporting part 14 at four corners of a lower surface as illustrated in FIG. 6. Lower spring fixing parts 111f include lower bosses 111g configured to position and fix lower resilient supporting part 14.

AF coil parts 112 are air-cored coils energized during focusing, and are each wound on an outer peripheral surface of coil winding wire part 111a of lens holder 111. Both end parts of AF coil parts 112 are respectively tied up by tie-up parts (not illustrated) of upper spring fixing parts 111d. AF coil parts 112 of AF movable parts 11a and 11b are wound in directions different from each other. For example, when AF coil part 112 of AF movable part 11a is wound clockwise, AF coil part 112 of AF movable part 11b is wound counterclockwise, and in contrast, when AF coil part 112 of AF movable part 11a is wound counterclockwise, AF coil part 112 of AF movable part 11b is wound clockwise. Accordingly, even when directions of polarity of permanent magnets 122A to 122D and 122E to 122H surrounding AF movable parts 11a and 11b are different, AF movable parts 11a and 11b can be moved respectively in the same manner along the optical axis direction by passing a current to AF coil parts 112.

AF fixing part 12 includes magnet holder 121 and magnet part 122. Magnet part 122 is attached to magnet holder 121 after AF movable part 11 is inserted into magnet holder 121. In AF fixing part 12, magnet part 122 is arranged so as to surround a lens mounting region where a plurality of lens parts 2a and 2b are mounted.

Magnet holder 121 has a shape that allows lens parts 2a and 2b disposed in the lens mounting region to be driven. Magnet holder 121 in this embodiment has a cylindrical shape rectangular in plan view and constitutes the lens mounting region with a portion radially inside side walls provided at four sides. Magnet holder 121 has arcuate grooves 121a depressed radially inward on an outer surface at four connecting part between side walls (corners of magnet holder 121). Arcuate grooves 121a accommodate suspension wires 30.

Magnet holder 121 includes on an upper portion thereof upward protruding parts 121b protruding radially inward on an inner peripheral surface at four corners of openings surrounding respective lens holders 111. Upward protruding parts 121b are arranged at positions avoiding upper spring fixing parts 111d of lens holder 111 and arranged to face upper surfaces of coil winding wire parts 111a.

In addition, magnet holder 121 includes upper spring fixing parts 121c configured to fix upper resilient supporting part 13 at four corners of an upper portion thereof. Upper spring fixing parts 121c include projecting strip portions and upper bosses projecting upward and configured to position and fix upper resilient supporting part 13. Upper spring fixing parts 111d of lens holders are spaced apart at substantially the same height radially inside upper spring fixing parts 121c.

Magnet holder 121 includes lower spring fixing parts 111f (see FIG. 6) configured to fix lower resilient supporting part 14 at four corners of a lower surface thereof. Lower spring fixing parts (see FIG. 6) include lower bosses 121h for positioning and fixing lower leaf spring parts 14a and 14b which constitute lower resilient supporting part 14.

Magnet part 122 includes eight cuboid-shaped permanent magnets 122A to 122H arranged so as to surround each of lens parts 2a and 2b (see FIG. 2) arranged side by side. Permanent magnets 122A to 122D are arranged so as to surround coil parts 112 of AF movable parts 11a, and permanent magnets 122E to 122H are arranged so as to surround coil parts 112 of AF movable parts 11b. In this embodiment, permanent magnets 122A to 122H are arranged along inner surfaces of four side walls and partitioning wall at a center of magnet holder 121. Permanent magnets 122A, 122C, 122E, and 122G are arranged to face each other in the Y direction, and permanent magnets 122B, 122D, 122F and 122H are arranged to face each other in the X direction. Upward protruding parts 111b of lens holders 111 are positioned in a space S between magnet part 122 and upward protruding parts 121b of magnet holder 121.

Permanent magnets 122A to 122H are magnetized so that a magnetic field orthogonal to a radial direction is formed toward respective AF coil parts 112 of AF movable parts 11a and 11b. Permanent magnets 122A to 122D and permanent magnets 122E to 122H are arranged so that permanent magnets 122D and 122F face each other with different polarities in order to prevent magnetic interference between permanent magnets 122D and 122F adjacent to each other at a center.

In this embodiment, as illustrated in FIG. 7 and FIG. 8, permanent magnets 122A to 122D surrounding one of the lens parts to be mounted are magnetized in S pole on an inner peripheral side, and in N pole on an outer peripheral side, and permanent magnets 122E to 122H are magnetized in N pole on an inner peripheral side, and in S pole on an outer peripheral side. Therefore, permanent magnets 122D and 122F arranged in proximity at a center of magnet holder 121 are arranged in such a manner that the N pole of permanent magnet 122D and the S pole of permanent magnet 122F face each other. Accordingly, a flow of a magnetic flux between permanent magnets 122D and 122F flows from permanent magnet 122D to permanent magnet 122F, and thus no magnetic interference occurs. In this case, in magnet part 122 of magnet holder 121, sets of permanent magnets that surround lens parts 2a and 2b respectively are arranged so that directions of magnetization are opposite from each other.

Therefore, even in a configuration in which a plurality of lens parts with AF function are arranged, there is no need to form gaps for preventing magnetic interference between permanent magnets 122D and 122F which constitute the AF functions of the respective lens parts, and a compact configuration of a so-called dual camera having a plurality of lens parts 2a and 2b is achieved.

In this embodiment, in permanent magnets 122A to 122H arranged so as to surround the respective AF movable parts 11a and 11b, permanent magnet 122D and permanent magnet 122F arranged in proximity to each other are provided. Alternatively, permanent magnet 122D and permanent magnet 122F may be configured as a single permanent magnet having both functions. In this case, the number of permanent magnets may be reduced and a space for one permanent magnet in magnet holder 121 is sufficient, and thus the configuration may be simplified. In addition, a compact configuration may be achieved.

Magnet part 122 and AF coil parts 112 constitute the AF voice coil motor. Magnet part 122 may function as both an AF magnet part and the OIS magnet part.

In addition, one end surface of permanent magnet 122A in the longitudinal direction and an end surface of permanent magnet 122B adjacent thereto in the longitudinal direction may be coupled to each other with a coupling yoke having a W shape in plan view, not illustrated. In the same manner, one end surface of permanent magnet 122C in the longitudinal direction and an end surface of permanent magnet 122D adjacent thereto in the longitudinal direction may be coupled to each other with a coupling yoke having a W shape in plan view, not illustrated.

Upper resilient supporting part 13 is, for example, a leaf spring formed of berylium copper, nickel copper, stainless steel, or the like, and includes upper leaf spring parts 13a, 13b each having a square shape as a whole in plan view. In this embodiment, upper leaf spring parts 13a and 13b resiliently support respective AF movable parts 11a and 11b with respect to AF fixing part 12.

Upper leaf spring parts 13a and 13b each are composed of a pair of spring members. The pair of spring members have a symmetrical shape.

Upper leaf spring parts 13a and 13b each include lens holder fixing part 131 to be fixed to lens holder 111 of AF movable parts 11a and 11b, magnet holder fixing part 132 disposed on radially outside lens holder fixing part 131 and fixed to magnet holder 121, and arm shaped resilient coupling parts 133 configured to couple lens holder fixing parts 131 and magnet holder fixing parts 132. Upper leaf spring parts 13a and 13b have a similar basic structure in which lens holder fixing parts 131 and magnet holder fixing parts 132 and resilient coupling parts 133 are arranged in a semi-circular shape.

Upper leaf spring parts 13a and 13b may be configured to serve as power source line parts configured to supply power to components that require power supply on AF movable parts 11a and 11b side. Each of upper leaf spring parts 13a and 13b, that is, lens holder fixing part 131, magnet holder fixing part 132, and resilient coupling part 133 may be formed by punching and cutting a single plate.

Also, upper leaf spring parts 13a and 13b may each have a function as a signal line part. The function as the signal line parts of upper leaf spring parts 13a and 13b is achieved by connecting suspension wires 31 to 34 for extracting a position detection signal (see FIG. 4) of AF coil parts 112 to one of end portions and connecting a signal terminal of a substrate for position detection (not illustrated) to the other end portion.

Lens holder fixing part 131 and magnet holder fixing part 132 may be relatively movable in an XY plane in XY axis directions by resilient deformation of resilient coupling part 133.

Lens holder fixing parts 131 are fixed to upper spring fixing parts 111d of lens holders 111 by engaging upper bosses.

Lens holder fixing parts 131 include a tie-up part connecting portion (not illustrated) to be connected to one end portions of AF coil parts 112, which is tied up to a tie-up part of upper spring fixing parts 111d.

Magnet holder fixing parts 132 are fixed to upper spring fixing parts 121c by engaging projecting strip portions and upper bosses. Magnet holder fixing parts 132 include wire connecting parts 132a and suspension wires 31 to 34 (see FIG. 4) are connected to wire connecting parts 132a. When a wire for power supply to AF coil part 112 out of suspension wires 31 to 34 is connected, electrical connection to AF coil parts 112, which is to be connected to the tie-up part connecting portion of lens holder fixing part 131 via wire connecting parts 132a, magnet holder fixing part 132, and resilient coupling part 133, is achieved.

In the same manner as upper resilient supporting part 13, lower resilient supporting part 14 is, for example, a leaf spring formed of berylium copper, nickel copper, stainless steel, or the like, and includes lower leaf spring parts 14a and 14b each having a square shape as a whole in plan view. In this embodiment, lower leaf spring parts 14a and 14b resiliently support respective AF movable parts 11a and 11b with respect to AF fixing part 12. Lower leaf spring parts 14a and 14b are each formed by punching and cutting a single plate, and alternatively, lower leaf spring parts 14a and 14b may be formed as an integral part.

Lower leaf spring parts 14a and 14b each include four spring parts 14A to 14D. Spring parts 14A to 14D each include lens holder fixing part 141a to be fixed to lens holder 111, magnet holder fixing part 141b disposed radially outside lens holder fixing part 141a and fixed to magnet holder 121, and arm part 141c configured to couple lens holder fixing part 141a and magnet holder fixing part 141b.

Adjacent lens holder fixing parts 141a are coupled by inner ring part 141d.

Lens holder fixing part 141a includes fixing hole 14f corresponding to lower boss 111g of lens holder 111. Magnet holder fixing part 141b is connected to lens holder fixing part 141a disposed in the vicinity of adjacent magnet holder fixing part 141b via arm part 141c arranged so as to face inner ring part 141d on the outside thereof. Magnet holder fixing part 141b includes fixing hole 14g corresponding to lower boss 121h of magnet holder 121.

A damper material (not illustrated) may be disposed between resilient coupling parts 133 of upper leaf spring parts 13a and 13b and magnet holder 121. Accordingly, generation of unwanted resonance (higher order resonance mode) may be suppressed, so that the stability of the operation is ensured. The damper material may be easily applied using a dispenser. As the damper material, for example, an ultraviolet curable silicone gel may be applied.

In this manner, in lens driving device 1, OIS movable part 10 that functions also as AF driving part includes AF coil part (112) and magnet part (122). AF coil parts (112) are arranged respectively so as to surround respective lens parts 2a and 2b (see FIG. 2). Magnet part (122) includes four permanent magnets (122A to 122D) magnetized radially of lens parts 2a and 2b (see FIG. 2) and arranged into a square frame shape, and is arranged radially apart from AF coil part (112). AF driving part (OIS movable part 10) utilizes a driving force of a voice coil motor composed of AF coil parts (112) and magnet part (122) that functions as shake correcting magnet part and AF magnet part to achieve automatic focusing by moving AF movable part (11) including AF coil parts (112) in the optical axis direction with respect to AF fixing part (12) including magnet part (122).

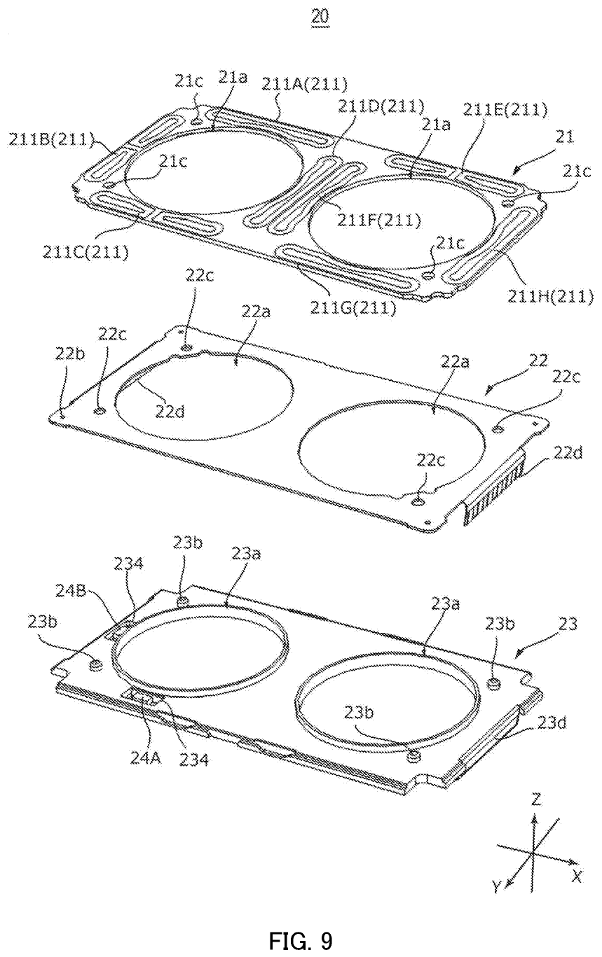

FIG. 9 is an exploded perspective view of OIS fixing part 20. As illustrated in FIG. 9, OIS fixing part 20 includes coil substrate 21, sensor substrate 22, base member 23, and the like.

Coil substrate 21 is a substrate having a rectangular shape in plan view, and coil substrate 21 includes a plurality of circular openings 21a formed side by side. In this embodiment, openings 21a are arranged symmetrically in plan view. Coil substrate 21 is cut out at four corners and the other ends (lower ends) of suspension wires 30 are disposed in these cutouts. Coil substrate 21 includes positioning holes 21c along a short side portions and in peripheral edge portions of openings 21a.

Coil substrate 21 includes OIS coil parts 211 at positions facing magnet part 122 in an optical axis direction. OIS coil part 211 includes eight OIS coils 211A to 211H corresponding to permanent magnets 122A to 122H. The sizes and positions of OIS coils 211A to 211H and permanent magnets 122A to 122H are set so that magnetic fields radiated from end faces of permanent magnets 122A to 122H traverse across respective long side portions of OIS coils 211A to 211H in the Z direction. Magnet part 122 and OIS coil parts 211 constitute the OIS voice coil motor.

In this specification, OIS coils 211B, 211C, and 211E are divided coils. In OIS coil part 211, OIS coils 211B and 211C extending along X-axis direction and Y-axis direction are divided coils and Hall elements 24A and 24B are disposed between the divided coils, respectively. OIS coils 211B and 211C are arranged around a periphery of AF movable part 11a out of a plurality of AF movable parts 11a and 11b. In a plurality of AF movable parts 11a and 11b, when two divided coils 211B and 211C are present in the periphery of AF movable part 11a out of a plurality of AF movable parts 11a and 11b, a magnetic circuit for OIS is significantly different between the plurality of AF movable parts 11a and 11b and thus OIS coil 211E, which is a divided coil, is arranged on AF movable part 11b.

In the same manner as coil substrate 21, sensor substrate 22 is a substrate having a rectangular shape in plan view, and sensor substrate 22 includes a plurality of circular openings 22a. Openings 22a, in this embodiment, openings 22a are arranged symmetrically in plan view in this embodiment. Sensor substrate 22 includes fixing holes 22b in which other ends (lower ends) of suspension wires 30 are inserted at four corners. Further, sensor substrate 22 has positioning holes 22c at positions corresponding to positioning holes 21c of coil substrate 21. Sensor substrate 22 includes engaging strips 22d formed by being bent downward at two sides along a Y direction. A power supply terminal and a signal terminal are disposed on each of engaging strips 22d.

Sensor substrate 22 includes a power supply line (not shown) for supplying power to AF coil parts 112 and OIS coil parts 211, and a signal line (not illustrated) for a detection signal outputted from Hall elements 24A and 24B.

In the same manner as coil substrate 21, base member 23 is a member having a rectangular shape in plan view and includes a plurality of circular openings 23a. Base member 23 has positioning bosses 23b at positions corresponding to positioning holes 21c of coil substrate 21 and positioning holes 22c of sensor substrate 22. Also, base member 23 includes large recess parts 23d on side walls at positions corresponding to engaging strips 22d. Base member 23 also includes hall element accommodating parts 234 for accommodating Hall elements 24A and 24B on peripheral edge portion of opening 23a.

Hall element accommodating parts 234 are provided in base member 23 in a peripheral edge portion of opening 23a at positions corresponding to positions between divided coils of OIS coils 211B and 211C, that is, at substantially centers in lengthwise direction.

Hall elements 24A and 24B are disposed on back side of sensor substrate 22, and are accommodated in Hall element accommodating parts 234 of base member 23. By detecting magnetic field formed by magnet part 122 with hall elements 24A and 24B, position of OIS movable part 10 in XY plane may be specified. XY position detecting magnet may be arranged in OIS movable part 10 separately from magnet part 122.

In this manner, lens driving device 1 includes OIS magnet part (magnet part 122) disposed in AF unit including AF movable part (11) and AF fixing part (12), and OIS coil part (211) disposed apart from OIS magnet part (122) in the optical axis direction. Lens driving device 1 achieves shake correction by swinging OIS movable part (10) including OIS magnet part (122) with respect to OIS fixing part (20) including OIS coil part (211) within a plane orthogonal to the optical axis direction by utilizing a driving force of a voice coil motor composed of OIS coil part (211) and OIS Magnet part (122).

In lens driving device 1, ends of suspension wires 31 to 34 are inserted into wire connecting parts 132a of magnet holder fixing parts 132 of upper leaf spring parts 13a and 13b and fixed by soldering. The ends of suspension wires 31 to 34 may be fixed respectively to wire connecting parts 132a of the power source line parts and the wire connecting parts of the power source line parts by soldering. Suspension wires 30 and upper leaf spring parts 13a and 13b, power source line parts, and the signal line parts are electrically connected.

Other ends (lower ends) of suspension wires 30 are inserted into fixing holes 22b of sensor substrate 22 and are fixed by soldering. Power source lines and signal lines of suspension wires 30 and sensor substrate 22 may be electrically connected accordingly. In other words, power supply to and operation control of AF coil parts 112 are enabled via suspension wires 30 and upper resilient supporting part 13.

In addition, upper leaf spring parts 13a and 13b are formed into a curved shape and are configured to be susceptible to resilient deformation. With the resilient deformation and warping of suspension wires 30, impact at the time of dropping is absorbed, so that plastic deformation or breakage of suspension wires 30 may be avoided.

For shake correction of lens driving device 1, OIS coil part 211 may be energized. When OIS coil part 211 is energized, a Lorentz force generates in OIS coil part 211 by an interaction between the magnetic field of magnet part 122 and current flowing in OIS coil part 211 (Fleming's low of left hand). The direction of Lorentz force is a direction (Y direction or X direction) orthogonal to a direction of magnetic field (Z direction) and a direction of a current flowing in a long side portions of OIS coil part 211 (X direction or Y direction). As OIS coil part 211 is fixed, a reaction force acts on magnet part 122. This reaction force works as a driving force for the OIS voice coil motor, and thus OIS movable part 10 having magnet part 122 swings in an XY plane, so that shake correction is achieved.

When automatic focusing is performed in lens driving device 1, AF coil parts 112 is energized. When AF coil parts 112 is energized, a Lorentz force is generated in AF coil parts 112 by an interaction between a magnetic field of magnet part 122 and a current flowing in AF coil parts 112. The direction of Lorentz force is a direction (Z direction) orthogonal to a direction of magnetic field (X direction or Y direction) or a direction (Y direction or X direction) of a current flowing in AF coil parts 112. As magnet part 122 is fixed, a reaction force acts on AF coil parts 112. The reaction force becomes the driving force of the AF voice coil motor to move AF movable part 11 having AF coil parts 112 in the optical axis direction, so that focusing is carried out.

At the time of non-energization when no focusing is performed, AF movable part 11 is in a state of being suspended between the infinity position and the macro position (hereinafter, referred to as “reference state”) by upper leaf spring parts 13a and 13b and lower leaf spring parts 14a and 14b. In other words, in OIS movable part 10, AF movable part 11 (lens holder 111) is resiliently supported so as to be displaceable to both sides of a Z-direction in a state of being positioned with respect to upper leaf spring parts 13a and 13b, lower leaf spring parts 14a and 14b, and AF fixing part 12 (magnet holder 121).

For focusing, the direction of current is controlled depending on whether AF movable part 11 is moved from the reference state toward the macro position or toward the infinity position. Likewise, the magnitude of current is controlled depending on a distance that AF movable part 11 has moved.

When AF movable part 11 moves toward the infinity position at the time of focusing, lower surfaces of upward protruding parts 111b of lens holder 111 approach and finally come into abutment with an upper surface of magnet part 122. In other words, the movement toward infinity position is restricted by the lower surfaces of upward protruding parts 111b of lens holder 111 and the upper surface of magnet part 122.

In contrast, when AF movable part 11 moves toward the macro position at the time of focusing, upper surfaces of upward protruding parts 111b of lens holder 111 approach and finally come into abutment with the lower surfaces of upward protruding parts 121b of magnet holder 121. In other words, the movement toward the macro position is restricted by the upper surfaces of upward protruding parts 111b of lens holder 111 and the lower surfaces of upward protruding parts 121b of magnet holder 121.

According to the present embodiment, permanent magnets 122A to 122H facing OIS coils 211A to 211H in the Z direction and arranged around AF movable parts 11a and 11b are arranged in proximity so that permanent magnets 122D and 122F face each other in the X direction. Here, the direction of magnetization of permanent magnets 122D and 122F are the same. Therefore, permanent magnet group (122A to 122D) arranged on four sides around AF movable part 11a together with permanent magnet 122D and permanent magnet group (122E to 122H) arranged on four sides around AF movable part 11b together with permanent magnet 122F both function as magnets for shake correction and each function as a magnet for AF driving.

In other words, even when the permanent magnet group to be arranged respectively around AF movable parts 11a and 11b are arranged in proximity, no mutual magnetic interference occurs and AF function for each of AF movable parts 11a and 11b are preferably realized.

AF driving part of lens driving device 1 is configured in such a manner that AF is moved only in the Z-axis direction. However, AF driving part may be provided with a position detecting unit configured to detect AF position and configured to perform a closed-loop control based on a detected signal of position detecting unit. According to the closed-loop control system, it is possible to directly detect that the position of AF movable part 11 is stabilized without considering hysteresis characteristics of the voice coil motor. In addition, the closed-loop control system may support an automatic focusing of an image surface detection system. Therefore, high response performance is achieved and thus the speed of an automatic focusing operation may be increased.

In lens driving device 1, a plurality of lens barrels of a plurality of lens parts 2, here, two lens parts 2 may be mounted at a time. Accordingly, mounting of lens barrels having different issue distances which work for wide field of view and telephoto or mounting a plurality of lens parts 2 having similar configurations is achieved. For example, by mounting lens parts 2 having different focal distances and focusing one lens part to macro and the other lens part to infinity at the time of photographing, simultaneous photographing of an object with different focuses may be achieved. OIS shift amount is different depending on the focal distance. Therefore, in this embodiment, stereo photographing, which is a technique of photographing an object simultaneously from different directions even with lenses having the same focal distance is enabled for the respective focal distances. Depending on the photographed images, changing the focal distance of photographed images by processing using software is also possible.

In this embodiment, by moving OIS movable part 10 with respect to OIS fixing part 20, a plurality of lens parts 2 are moved simultaneously in the X-axis direction and the Y-axis direction by the same distance to correct hand shaking of lens driving device 1.

With two lens parts 2 mounted on one actuator, a dual camera smaller than dual cameras of the related art having an actuator for each of the plurality of lens parts is achieved.

In this embodiment, although two lens parts 2 are described to be mounted on OIS movable part 10, three or more lens parts 2 may be mounted. When three or more lens parts are mounted, a configuration in which the lens parts are preferably located concentrically, or concentrically and at a center.

Likewise, although four suspension wires 31 to 34 are described to be provided as resilient supporting member 30 for supporting OIS movable part 10, OIS movable part 10 may be supported so as to be movable in the X-axis direction and the Y-axis direction with respect to OIS fixing part 20 with a plurality, such as six, eight, and the like, of suspension wires.

The invention of the present inventor has been specifically described in accordance with the embodiment. However, the present invention is not limited to the above-described embodiment, and may be changed without departing from the gist of the present invention.

For example, in the embodiment, lens driving device 1 provided with AF function and OIS function has been described. In addition, the present invention may be applied to a lens driving device provided with a plurality of lens parts without having the AF function, and also to a lens driving device in which at least one of the lens parts is provided with the AF function.

For example, in the embodiment, the example of the smart phone has been described as the camera-mounted device provided with camera module A for describing camera module A having lens driving device 1. However, the present invention may be applied to camera-mounted device which is an information device or a transporting device. The camera-mounted device which is an information device including a camera module is an information device including a controller configured to process image information obtained by the camera module, and for example, includes mobile telephone with a camera, lap-top personal computer, tablet terminal, mobile game machine, web camera, vehicle-mounted device with a camera (for example, back-view monitor device, driving recorder device, and the like). The camera-mounted device which is a transporting device includes a transporting device having a camera module and a controller configured to process images obtained by the camera module, and for example, includes automotive vehicle.

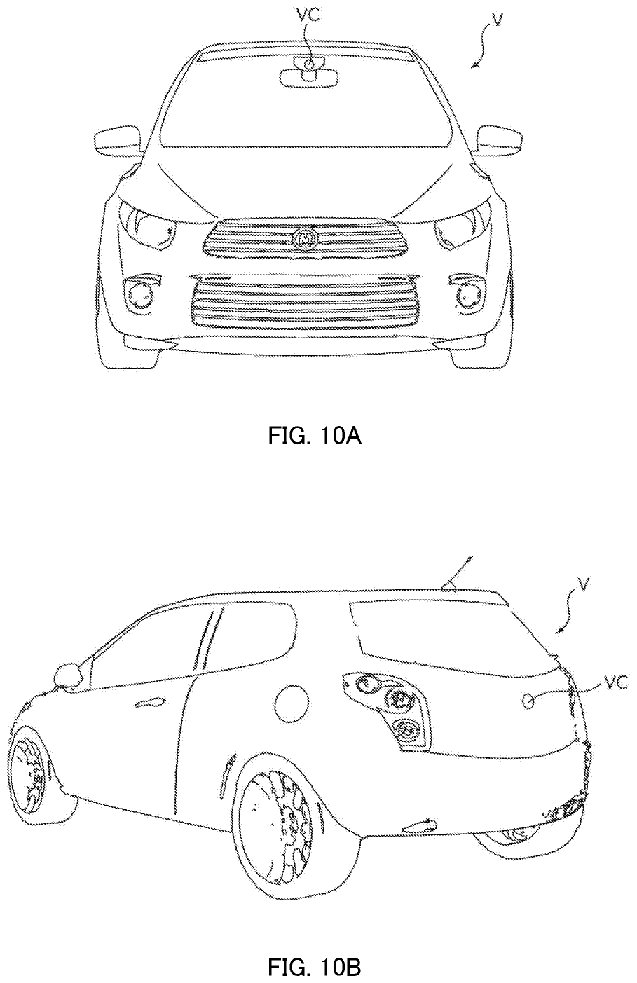

FIGS. 10A and 10B are drawings of automotive vehicle C as a camera-mounted device provided with vehicle-mounted camera module VC (Vehicle Camera). FIG. 10A is a front view of vehicle C, and FIG. 10B is a rear perspective view of vehicle C. Vehicle C includes camera module A described in the embodiment mounted thereon as vehicle-mounted camera module VC. As illustrated in FIGS. 10A and 10B, vehicle-mounted camera module VC is attached to a front glass so as to face forward, or is attached to a rear gate so as to face rearward, for example. Vehicle-mounted camera module VC is used for a back monitor, a driving recorder, collision avoidance control, automatic driving control, and the like.

In addition, four each of permanent magnets 122A to 122H are arranged around respective lens parts 2 in the embodiment. However, the permanent magnets are not limited thereto and may be arranged by any number and at any positions as long as OIS movable part 10 is movable in the X-axis direction and the Y-axis direction. Arranging at least two permanent magnets orthogonally adjacent to each other around each of lens parts 2 (for example, a configuration in which only permanent magnets 122A and 122B, and 122E and 122H are remained from the configuration described above, or the like) and configuring with four, six, or seven permanent magnets in total are also applicable.

The embodiments disclosed here are to be considered as examples only in all respects and are not intended to limit the invention. The invention is not defined by the above described description, but is defined by the appended claims and is intended to include any modification within the meaning and scope equivalent to the appended claims.

The disclosure of the specification, drawings and the abstract included in Japanese Patent Application No. 2016-150291 filed Jul. 29, 2016 is all incorporated herein by reference.

### INDUSTRIAL APPLICABILITY

The lens driving device, the camera module, and the camera-mounted device according to the present invention have the effect of easily realizing miniaturization of a dual camera, and particularly, are useful as being applied to a mobile terminal with a camera such as a smart phone.

### REFERENCE SIGNS LIST

1 Lens driving device
2, 2a, 2b Lens part
3 Shield cover
10 OIS movable part
11, 11a, 11b AF movable part
12 AF fixing part
13 Upper resilient supporting part
13a, 13b Upper leaf spring part
14 Lower resilient supporting part
14a, 14b Lower leaf spring part
20 OIS fixing part
21 Coil substrate
21a, 22a, 23a Opening
22 Sensor substrate
23 Base member
24A, 24B Hall element
30 to 34 Suspension wire (resilient supporting member)
111 Lens holder (lens mounting part)
112 AF coil part
121 Magnet holder
122 Magnet part
122A to 122H Permanent magnet
131, 141a Lens holder fixing part
132, 141b Magnet holder fixing part
133 Resilient coupling part
141c Arm part
141d Inner ring part
211 OIS coil part
211A to 211H OIS coil
234 Hall element accommodating part
OC1 OC2 camera

1. A lens driving device, comprising:
a shake correcting driving part that includes:
a shake correcting magnet part disposed so as to surround a lens part placing region where a lens part is placed, and
a shake correcting coil part disposed apart from the shake correcting magnet part in an optical axis direction,
wherein the shake correcting driving part sways a shake correcting movable part including the shake correcting magnet part with respect to a shake correcting fixing part including the shake correcting coil part in a plane orthogonal to the optical axis direction by using a driving force of a voice coil motor including the shake correcting coil part and the shake correcting magnet part; and
a resilient supporting member that supports the shake correcting movable part so that the shake correcting movable part is capable of swaying with respect to the shake correcting fixing part, wherein
the shake correcting movable part includes a plurality of lens mounting parts that accommodate a plurality of the lens parts respectively in the lens part placing region.

2. The lens driving device according to claim 1, wherein
at least one of the plurality of lens mounting parts includes an autofocusing coil part that is disposed around the lens part accommodated in at least one of the lens mounting parts; and
the shake correcting magnet part functions as an autofocusing magnet part that is disposed radially apart from the autofocusing coil part and forms a voice coil motor together with the autofocusing coil part, and moves the lens mounting parts in the optical axis direction by using a driving force of the voice coil motor.

3. The lens driving device according to claim 2, wherein:
each of the plurality of lens mounting parts comprises the autofocusing coil part,
the shake correcting magnet part comprises:
a first permanent magnet group that includes a plurality of permanent magnets disposed around a first lens mounting part of the plurality of lens mounting parts on four sides, the plurality of permanent magnets each having the same polarity on a side of the first lens mounting part and functioning also as the autofocusing magnet part for the first lens mounting part, and
a second permanent magnet group that includes a plurality of permanent magnets disposed around a second lens mounting part of the plurality of lens mounting parts on four sides, the plurality of permanent magnets each having the same polarity on the second lens mounting part side and functioning also as the autofocusing magnet part for the second lens mounting part, and wherein:
the polarity of the permanent magnets in the first permanent magnet group on the first lens mounting part side and the polarity of the permanent magnets in the second permanent magnet group on the second lens mounting part side are different from each other, and
the permanent magnets of the first permanent magnet group and the permanent magnets of the second permanent magnet group disposed between the plurality of lens mounting parts are arranged in such a manner that different magnetic polarities face each other.

4. The lens driving device according to claim 2, wherein:
the permanent magnets of the first permanent magnet group and the permanent magnets of the second permanent magnet group disposed between the plurality of lens mounting parts are made of a single permanent magnet, and
the single permanent magnet is disposed in such a manner that different magnetic polarities face respectively to the first lens mounting part and the second lens mounting part.

5. A camera module, comprising:
a lens driving device according to claim 1;
a plurality of lens parts that are mounted respectively on the lens mounting parts; and
an image capturing part configured to capture a subject image imaged by the lens part.

6. A camera-mounted device that is an information device or a transporting device, the camera-mounted device comprising the camera module according to claim 5.
